(19) United States
(12) Patent Application Publication
(10) Pub. No.: US 2009/0300666 A1
(43) Pub. Date: Dec. 3, 2009

(54) Disk loading device and disk device

(75) Inventors: Akihiro Fukasawa, Kyoto (JP); Masanori Ootomo, Tokyo (JP)

Correspondence Address: BIRCH STEWART KOLASCH & BIRCH, PO BOX 747, FALLS CHURCH, VA, 22040-0747, US

(73) Assignee: SAINT-GOBAIN CENTRE DE, COURBEVOIE (FR)

(21) Appl. No.: 11/922,100

(22) PCT Filed: Apr. 4, 2006
(86) PCT No.: PCT/JP2006/307095

§ 371 Date: Dec. 13, 2007

(30) Foreign Application Priority Data
Sep. 8, 2005 (JP) 2005-260377

(51) Int. Cl. G11B 17/04

(52) U.S. Cl. 720/621; G9B/17.013

(57) ABSTRACT

A disk loading device includes a driving roller (6) that rotates, and a disk guide (8) that holds an optical disk (3) between the driving roller (6) and the disk guide (8). The disk guide (8) includes a pressing portion (8a, 8b, 8c and 8d) disposed in opposition to the driving roller (6), a swinging shaft (8e, 8f) supported by a shaft receiving portion (11a, 11b), and a spring (10a, 10b) that urges the disk guide (8) toward the driving roller (6). The shaft receiving portion (11a, 11b) supports the swinging shaft (8e, 8f) so that an inclination of the disk guide (8) with respect to the rotation axis of the driving roller (6) is changeable.

### TECHNICAL FIELD

This invention relates to a disk device of a slot-in type in which a disk medium such as CD (Compact Disk), DVD (Digital Versatile Disk) or the like is directly loaded, and relates to a disk loading device provided in the disk device.

### BACKGROUND ART

Conventionally, there is known a disk device of a slot-in type in which a disk medium is directly loaded and unloaded (without using a tray). The disk device of such type is configured to hold a disk medium (inserted through an insertion opening) by a driving roller and a disk guide therebetween, and feed the disk medium to a predetermined position by the rotation of the driving roller. The driving roller has a shape such that the center in the axial direction is narrower than both ends in the axial direction, so that the driving roller and the disk guide hold both edges of the disk medium therebetween (see, for example, Patent Document No. 1).

Patent Document No. 1: Japanese Laid-Open Patent Publication No. 2003-77198 (Pages 3-4, FIG. 6).

### DISCLOSURE OF THE INVENTION

### Problems to be Solved by the Invention

However, in the conventional disk device, the disk guide is fixed parallel to the driving roller. Therefore, if deformation (distortion, warping or the like) of the disk guide occurs in the fabrication stage, or if a disk guide is not evenly pressed against the driving roller, a holding force of the driving roller and the disk guide differs between both edges of the disk. As a result, there is a problem that the disk medium is obliquely fed and abuts against other components, or the feeding is stopped due to the increase of the feeding load of the driving roller.

Further, if a disk device is inserted to a position shifted from the center of the driving roller, the holding force of the driving roller and the disk guide becomes unbalanced between both edges of the disk. Therefore, there is a problem that the disk medium is obliquely fed, or the feeding is stopped due to the increase of the feeding load of the driving roller.

Furthermore, when the disk device is used as a home-use DVD player, there is a case where the disk device is so oriented that the disk surface is perpendicular to a ground surface (so-called vertical orientation). When a disk medium of small diameter (for example, a disk medium of 8 cm in diameter) is inserted in such a vertically-oriented disk device, the disk tends to be shifted from the center of the driving roller. In the conventional disk device, the outer diameter of the center portion of the driving roller in the axial direction is narrower than both ends of the driving roller. Therefore, when the disk medium is shifted from the center of the driving roller, the holding force of the driving roller and the disk guide becomes uneven, so that there is a problem that the disk medium can not be fed to a predetermined loading position.

The present invention is intended to solve the above described problems, and an object of the present invention is to enable the disk guide and the driving roller to hold both edges of the disk medium therebetween with even force, and to enhance the reliability of feeding of the disk medium.

### Means of Solving the Problems

A disk loading device according to the present invention includes a driving roller that rotates to thereby feed a disk medium, a disk guide including a pressing portion disposed in opposition to said driving roller and a swinging shaft for swinging said pressing portion toward and away from said driving roller, a swinging supporting means that supports said swinging shaft of said disk guide, and an urging means that urges said pressing portion of said disk guide so that said pressing portion is pressed against said driving roller, wherein said swinging supporting means supports said swinging shaft so that an inclination of said disk guide with respect to an axial direction of said driving roller is changeable.

### Effect of the Invention

According to the present invention, if the driving roller is obliquely mounted in the fabrication stage, or if the disk medium is inserted to a position shifted from the center of the driving roller, the inclination of the disk guide changes so that the disk guide and the driving roller hold both edges of the disk medium therebetween with even force. As a result, the disk guide and the driving roller are capable of holding both edges of the disk with even force, and feeding the disk medium correctly along a predetermined feeding path. With this, it becomes possible to prevent the disk medium from abutting against other components, and to prevent the stoppage of the feeding due to the increase of the feeding load of the driving roller. In other words, a reliable disk loading device can be obtained.

### BRIEF DESCRIPTION OF THE DRAWINGS

FIG. 1 is an exploded perspective view of a disk device having a disk loading device according to Embodiment 1 of the present invention;

FIG. 2 is an exploded perspective view showing a supporting structure of a disk guide of the disk loading device according to Embodiment 1 of the present invention;

FIG. 3 is a perspective view showing the supporting structure of the disk guide of the disk loading device according to Embodiment 1 of the present invention;

FIG. 4 is a perspective view showing the supporting structure of the disk guide of the disk loading device according to Embodiment 1 of the present invention;

FIG. 5 is a perspective view showing the disk guide of the disk loading device according to Embodiment 1 of the present invention;

FIG. 6 is a side view showing the disk guide of the disk loading device according to Embodiment 1 of the present invention;

FIG. 7 is a front view showing a supporting structure of a swinging shaft of the disk guide of the disk loading device according to Embodiment 1 of the present invention;

FIG. 8 is a view showing a basic configuration of the disk device having the disk loading device a according to Embodiment 1 of the present invention;

FIG. 9 is a view showing the disk loading device when an optical disk is not inserted;

FIG. 10 is a view showing the disk loading device when an optical disk of large diameter is inserted;

FIG. 11 is a view showing the disk loading device when the disk of large diameter is inserted therein in a case where a driving roller is obliquely mounted;

FIG. 12 is a view showing the disk loading device when a disk of small diameter is inserted to a position shifted from the center of the driving roller;

FIG. 13 is an exploded perspective view showing a supporting structure of a disk guide of a disk loading device according to Embodiment 2 of the present invention;

FIG. 14 is a perspective view showing the supporting structure of the disk guide of the disk loading device according to Embodiment 2 of the present invention, and

FIG. 15 is an enlarged schematic view showing a swinging shaft of the disk guide and a hole portion shown in FIG. 13.

### DESCRIPTION OF REFERENCE MARKS

1 . . . housing, 1a, 2a . . . insertion opening, 2 . . . cover chassis, 3 . . . optical disk, 4 . . . roller supporting member, 4a, 4b . . . tapered surface, 4c, 4d . . . roller shaft supporting portion, 5 . . . roller shaft, 6 . . . driving roller, 7 . . . gear, 8 . . . disk guide, 8a, 8b, 8c, 8d . . . pressing portion, 8e, 8f . . . swinging shaft, 8g, 8h . . . projecting portion, 8k . . . escape portion, 8m . . . shutter, 8n, 8p . . . groove portion, 9a, 9b . . . screw, 10a, 10b . . . spring, 11a, 11b . . . shaft receiving portion, 11c . . . hole portion, 12 . . . clamper, 13 . . . turntable, 14 . . . spindle motor, 15 . . . optical head, 16 . . . driving chassis, 17 . . . optical disk (large diameter), 18 . . . optical disk (small diameter), 19 . . . shaft receiving portion.

### BEST MODE FOR CARRYING OUT THE INVENTION

### Embodiment 1

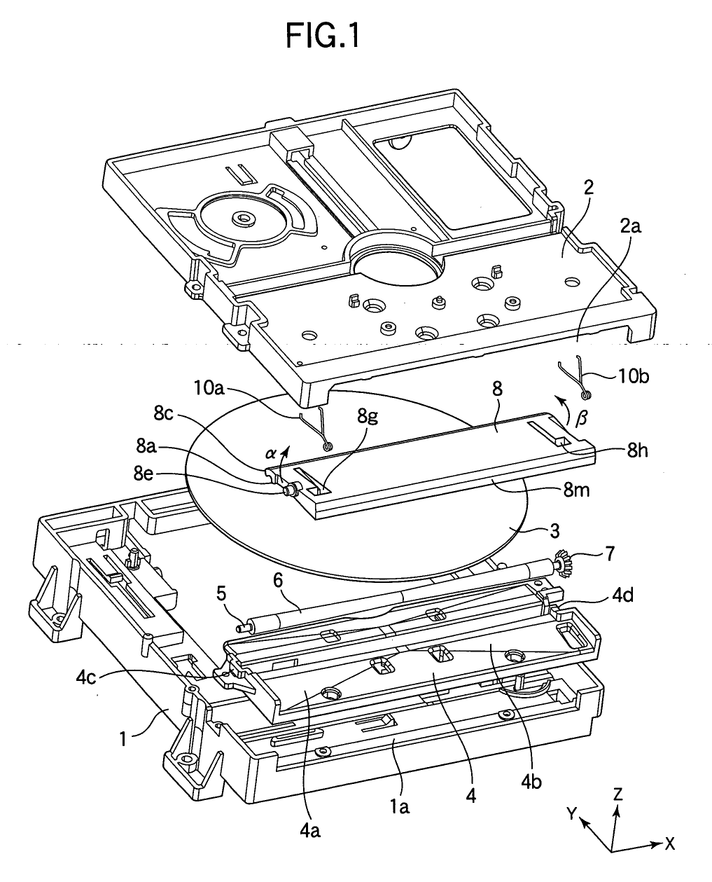

FIG. 1 is an exploded perspective view showing a disk device having a disk loading device according to Embodiment 1 of the present invention. The disk device is used as, for example, a home-use DVD player, and is configured to perform recording, reproducing or both of signals on an optical disk (a disk medium) 3.

As shown in FIG. 1, the direction of the rotation axis of the optical disk 3 is defined as Z direction. Along the Z direction, the direction from an optical head 15 (FIG. 8) toward the optical disk 3 is defined as +Z direction (upward), and the opposite direction is defined as −Z direction (downward). The loading/unloading direction of the optical disk 3 in the disk device is defined as Y direction. Along the Y direction, the loading direction of the optical disk 3 is defined as +Y direction, and the unloading direction is defined as −Y direction. On the surface parallel to the recording surface of the optical disk 3, the direction perpendicular to the Y direction is defined as X direction (left-right direction).

The disk device includes a main body composed of a box-shaped housing 1 whose upper surface is opened, and a cover chassis 2 covering the upper surface of the housing 1. On the front surface of the main body (the housing 1 and the cover chassis 2), insertion openings 1a and 2a are formed for inserting the optical disk 3. The openings 1a and 2a are combined with each other to form a rectangular opening.

A roller supporting member 4 is fixed to the upper side of the housing 1 in adjacent to the insertion openings 1a and 2a for the optical disk 3. The roller supporting member 4 is formed by injection molding using a synthetic resin having a small friction coefficient. Bilaterally-symmetric tapered surfaces 4a and 4b are formed on the upper surface of the roller supporting portion 4 so that the height of the upper surface of the roller supporting portion 4 is the lowest in the center and increases toward both ends of the roller supporting portion 4. Due to the tapered surfaces 4a and 4b, when the optical disk 3 contacts the roller supporting member 4, the roller supporting member 4 contacts both edges of the optical disk 3 but does not contact the recording surface.

The roller supporting portion 4 has side walls on both sides in the X direction (left-right direction). Roller shaft receiving portions 4c and 4d as concaves are formed on the side walls. A driving roller 6 is rotatably mounted to the roller shaft receiving portions 4c and 4d via a roller shaft 5. The driving roller 6 has a shape such that the outer diameter is the smallest in the center in the axial direction and gradually increases toward both ends (i.e., has an outer circumferential surface in the form of bilaterally-symmetric cones). The driving roller 6 is formed of a material having high friction coefficient such as a synthetic rubber, and is configured to rotate together with the metal roller shaft 5 extending in the X direction. A gear 7 is fixed to an end of the roller shaft 5. The driving force from the motor (not shown) disposed in the housing 1 is transmitted via a gear train (not shown) to the gear 7, and the driving roller 6 rotates about an axis of the X direction.

On the upper side (the +Z side) of the driving roller 6, a disk guide 8 is swingably mounted to the cover chassis 2. The disk guide 8 is formed by injection molding using a synthetic resin having a low friction coefficient.

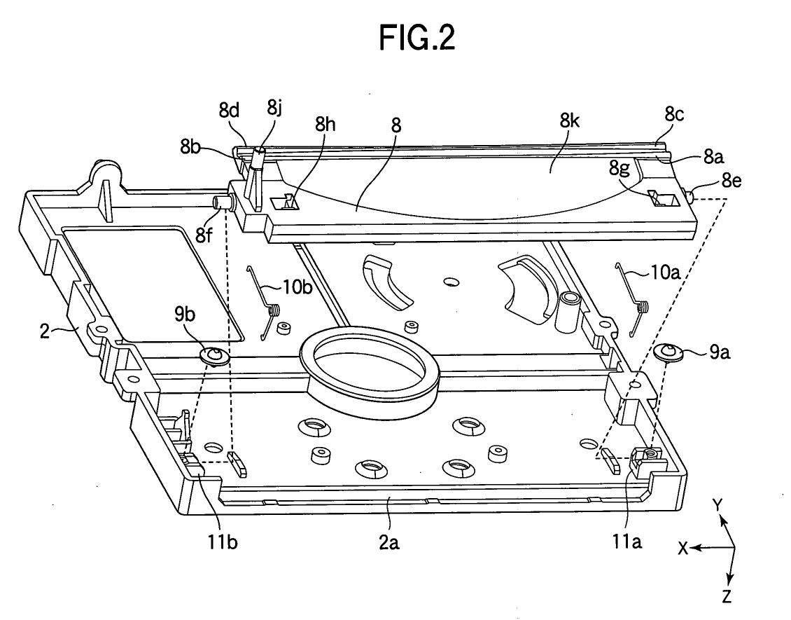

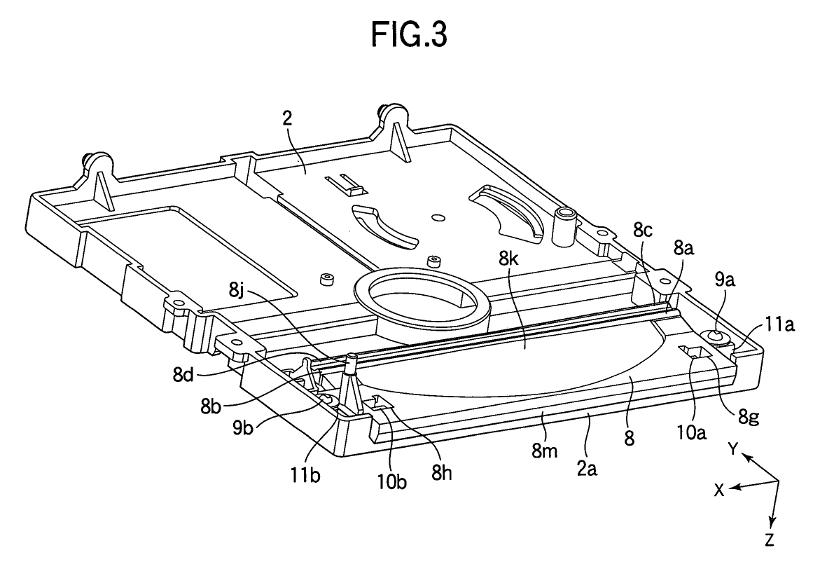

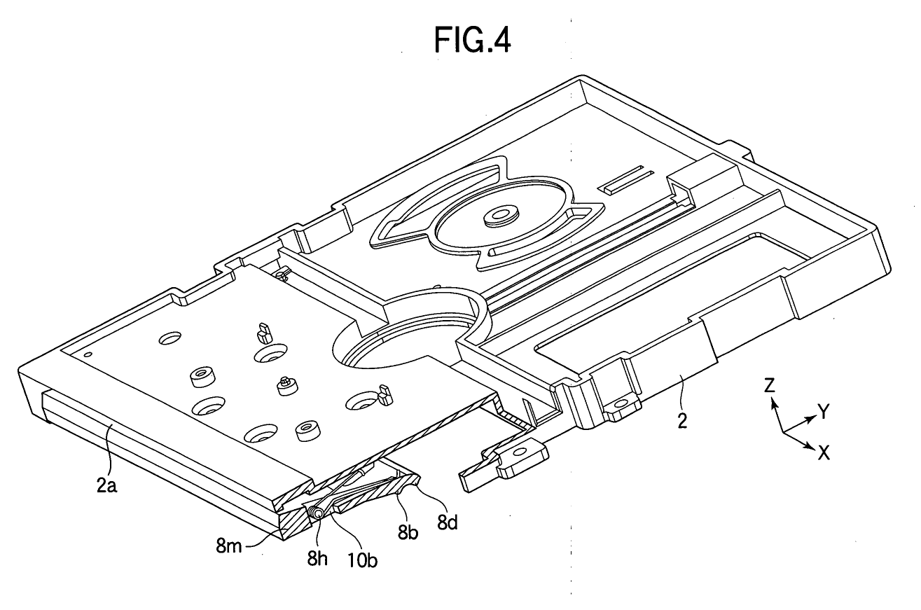

FIG. 2 is an exploded perspective view showing a supporting structure of the disk guide 8 of the disk loading device according to Embodiment 1, as seen from the driving roller 6 side. FIG. 3 is a perspective view showing the supporting structure of the disk guide of the disk loading device according to Embodiment 1, as seen from the driving roller 6 side. FIGS. 2 and 3 are illustrated in such a manner that the +Z direction is oriented downward. FIG. 4 is a perspective view showing the supporting structure of the disk guide of the disk loading device according to Embodiment 1.

As shown in FIG. 2, pressing portions 8a, 8b, 8c and 8d are formed on the tip of the disk guide 8 in the disk-loading direction (the +Y direction), and the pressing portions 8a, 8b, 8c and 8d face the driving roller 1 (FIG. 1). The pressing portions 8a and 8b are so formed that the outer diameter gradually increases (i.e., the protruding amount to the driving roller 6 side gradually increases) from the center in the X direction toward both ends in the X direction, and have bilaterally-symmetric conical surfaces. The pressing portions 8c and 8d are formed adjacent to the above described pressing portions 8a and 8b in the disk-loading direction (the +Y direction), and are formed in a similar manner to the pressing portions 8a and 8b.

The pressing portions 8a through 8d of the disk guide 8 are respectively face both ends (in the axial direction) of the driving roller 6 (FIG. 1). The pressing portions 8a, 8b, 8c and 8d and the driving roller 6 hold the optical disk 3 therebetween, and feed the optical disk 3 by the rotation of the driving roller 6. Further, the center portion of the disk guide 8 in the axial direction does not protrude toward the driving roller 6 side, and the outer diameter of the center portion of the driving roller 6 in the axial direction is smaller than the outer diameter of both ends of the driving roller 6. Therefore, when the disk guide 8 and the driving roller 6 hold both edges of the optical disk 3 therebetween, the disk guide 8 and the driving roller 6 do not contact the recording surface of the optical disk 3.

Left-to-right pair of swinging shafts 8e and 8f are formed on both ends of the disk guide 8 in the X direction and coaxially protrude in the X direction. The swinging shafts 8e and 8f engage the shaft receiving portions 11a and 11b formed on the cover chassis 2. Due to the engagement between the swinging shafts 8e and 8f and the shaft receiving portions 11a and 11b, the disk guide 8 is swingably supported by the cover chassis 2. As shown in FIGS. 2 and 3, the swinging shafts 8e and 8f are supported in the shaft receiving portions 11a and 11b by the screws 9a and 9b and their washers so that the swinging shafts 8e and 8f do not drop out of the shaft receiving portions 11a and 11b.

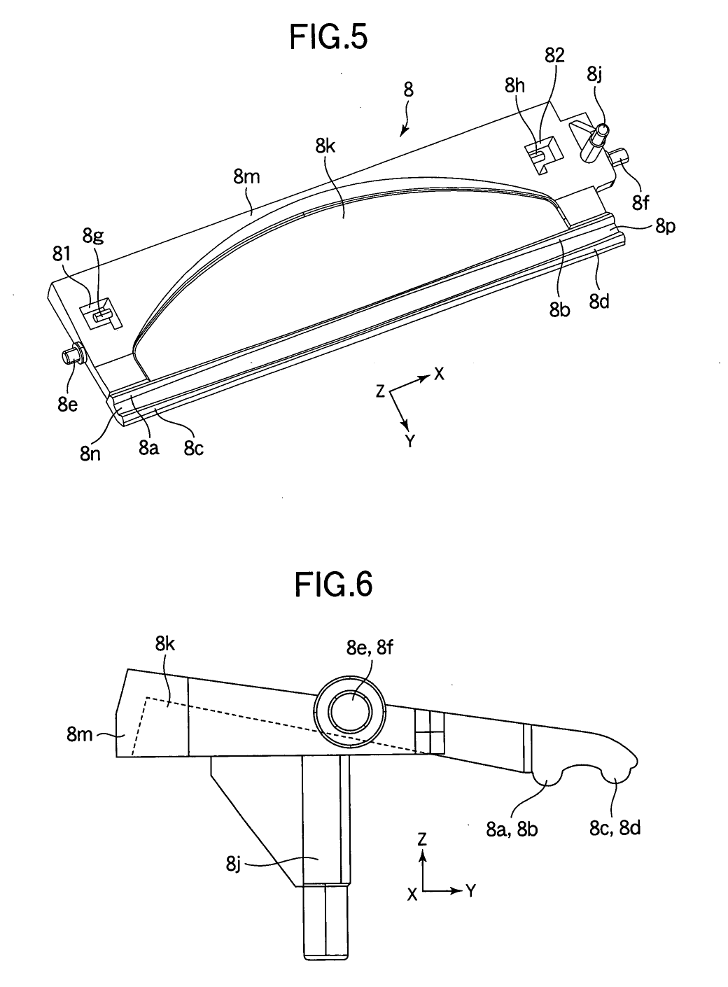

FIG. 5 is a perspective view showing a disk guide 8. FIG. 6 is a side view showing the disk guide 8. As shown in FIG. 5, openings 81 and 82 which are substantially rectangular-shaped are formed on the disk unloading side (the −Y direction) of the swinging shafts 8e and 8f of the disk guide 8. Left-to-right pair of projecting portions 8g and 8h are formed inside the openings 81 and 82. Springs 10a and 10b (FIG. 2) are mounted to the projecting portions 8g and 8h. As shown in FIG. 4, an end of the spring 10b presses the disk guide 8, and the other end of the spring 10b presses the cover chassis 2. The spring 10a is the same as the spring 10b. Due to the urging by the springs 10a and 10b, the pressing portions 8a, 8b, 8c and 8d formed on the tip of the disk guide 8 in the disk loading direction (the +Y direction) are urged to the driving roller 6 side (the −Z direction).

As shown in FIG. 5, a fixing boss 8j is formed on a side end of the disk guide 8 in the X direction. An escape portion 8k is formed on the surface (the surface of −Z direction) of the disk guide 8 facing the optical disk 3 for avoiding contact with the optical disk 3 when the disk guide 8 swings. As shown in FIG. 6, a shutter 8m is formed along the end portion of the disk guide 8 in the disk-unloading direction (the −Y direction). The shutter 8m has a length in the X direction longer than the diameter of the optical disk 3, and extends by a predetermined amount in the −Z direction (to such an extent that the shutter 8m can almost cover the insertion openings 1a and 2a).

When the loading of the optical disk 3 is completed, the disk guide 8 is swung by a not shown disk guide swinging mechanism, and the pressing portions 8a, 8b, 8c and 8d move in the +Z direction (i.e., move away from the optical disk 3). In this state, the fixing boss 8j engages a predetermined engaging portion in the housing 1 and is fixed, and the pressing portions 8a, 8b, 8c and 8d are held at positions apart from the optical disk 3. In this state, the shutter 8m of the disk guide 8 closes the insertion opening 1a and 2a so as to prevent the false insertion of the optical disk 3.

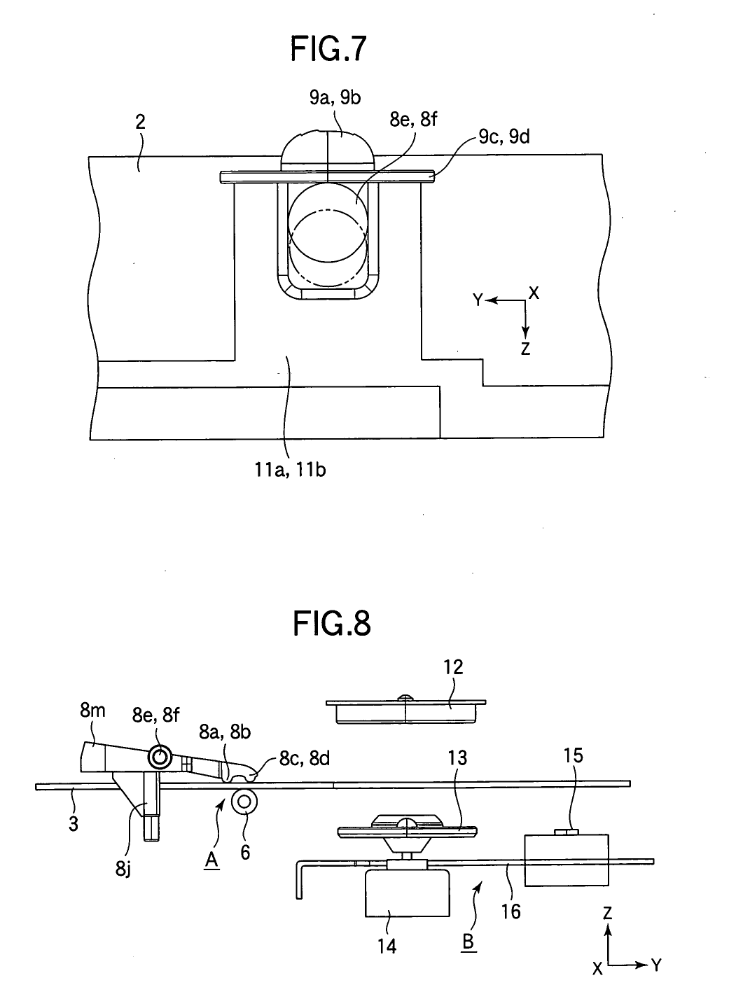

FIG. 7 is a side view showing a supporting structure of the disk guide 8. As shown in FIG. 7, the swinging shafts 8e and 8f engage the shaft receiving portions 11a and 11b provided on the cover chassis 2. The shaft receiving portions 11a and 11b formed on the cover chassis 2 have grooves which are substantially rectangular-shaped in the YZ plane, and −Z sides of the grooves are opened. The −Z sides of grooves of the shaft receiving portions 11a and 11b are closed by washers 9c and 9d fixed to the screws 9a and 9b. With this, the swinging shafts 8e and 8f of the disk guide 8 are rotatable in the grooves of the shaft receiving portions 11a and 11b. The lengths of the shaft receiving portions 11a and 11b in the Z direction are longer than the outer diameters of the swinging shafts 8e and 8f, so that the swinging shafts 8e and 8f are movable in the grooves in the Z direction. With such a structure, the inclination of the disk guide 8 is changeable.

In a state prior to the insertion of the optical disk 3, the swinging shafts 8e and 8f of the disk guide 8 are at the end position of the movable range in the −Z direction (shown by a solid line in FIG. 7). When the optical disk 3 is obliquely inserted with respect to the driving roller 6, one of the swinging shafts 8e and 8f of the disk guide 8 moves to a position shown by a dashed line in FIG. 7, so that the inclination of the disk guide 8 changes. In this regard, it has been described that the disk guide 8 is formed by injection molding using a synthetic resin. However, if there is no problem in machining accuracy, the disk guide 8 can be formed by press working using a metal plate, or can be formed by connecting a metal plate and a synthetic resin as needed.

FIG. 8 is a view showing a basic configuration of the disk device having the disk loading device according to Embodiment 1 of the present invention. As shown in FIG. 8, a disk driving device (indicated by mark B) is provided on the +Y side of the disk loading device (indicated by mark A) including the disk guide 8 and the driving roller 6. The disk driving device B includes a driving chassis 16, a turntable 13 rotatably supported by the driving chassis 16, a spindle motor 14 rotating the turntable 13, an optical head 15 movably supported by the driving chassis 16. On the +Z side of the driving chassis 16, a rotatable damper 12 is mounted to a clamp chassis (not shown) that is vertically movable.

The driving roller 6 is positioned between the pressing portions 8a and 8b and the pressing portions 8c and 8d of the disk guide 8 in the Y direction. The optical disk 3 is fed in such a manner that the optical disk 3 is held by the driving roller 6 and the pressing portions 8a, 8b, 8c and 8d of the disk guide 8 therebetween. In this state, the optical disk 3 is stably supported at total three points in the YZ plane: two points on the upper side (the +Z side) and one point at the lower side (the −Z side). When the driving roller 6 rotates, the optical disk 3 moves in the +Y direction (the loading direction) by the rotation force of the driving roller 6, and fed slidably contacting the pressing portions 8a, 8b, 8c and 8d.

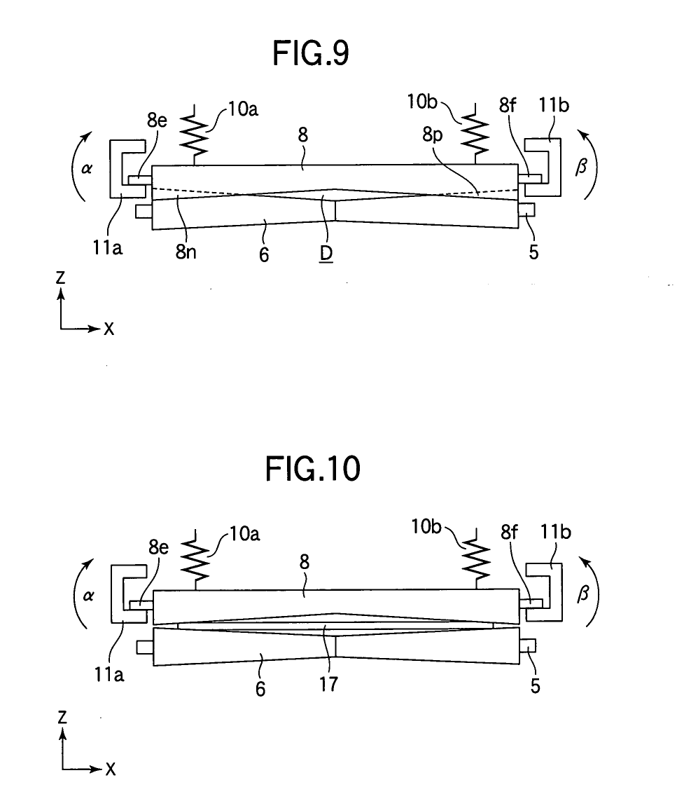

Next, the operation of the disk loading device according to this embodiment will be described. FIG. 9 is a view showing the disk loading device when the optical disk is not inserted, as seen from the insertion openings 1a and 2a (FIG. 1) side. As shown in FIG. 9, when the optical disk 3 is not inserted, the pressing portions 8a, 8b, 8c and 8d are pressed against the driving roller 6 by means of the urging force of the springs 10a and 10b. Both ends of the driving roller 6 in the axial direction (the X direction) are positioned in groove portions 8n and 8p between the pressing portions 8a and 8b and the pressing portions 8c and 8d. A clearance D is formed between the pressing portions 8a, 8b, 8c and 8d of the disk guide 8 and the driving roller 6. The clearance D is wide in the center in the X direction and becomes narrower toward both ends in the X direction. Due to the engagement between the shaft receiving portions 11a and 11b and the swinging shafts 8e and 8f, the inclination of the disk guide 8 is changeable in the directions indicated by arrows αand β.

FIG. 10 is a view showing the disk loading device when the optical disk 17 of large diameter (for example, 12 cm in diameter) is inserted, as seen from the insertion openings 1a and 2a side (FIG. 1). In FIG. 10, it is assumed that the optical disk 17 of large diameter is inserted so that the center of the optical disk 17 is aligned with the center of the driving roller 6 (i.e., the center of the disk guide 8). Further, it is assumed that the disk guide 8, the driving roller 8 and the roller supporting member 4 (FIG. 1) have no distortion, warping or the like. As shown in FIG. 10, when the optical disk 17 of large diameter is held by the driving roller 6 and the disk guide 8 therebetween, both edges of the optical disk 17 in the X direction are constantly held by the driving roller 6 and the disk guide 8 therebetween with even force.

However, for example, in the fabrication stage of the disk device, there are cases where distortion or warping of the disk guide 8 may occur, or distortion of warping of the roller supporting member 4 (FIG. 1) may occur. Further, due to the assembling error of the disk device, there are cases where the disk guide 8 and the driving roller 6 may be mounted obliquely, or the optical disk 3 may have warping or deformation.

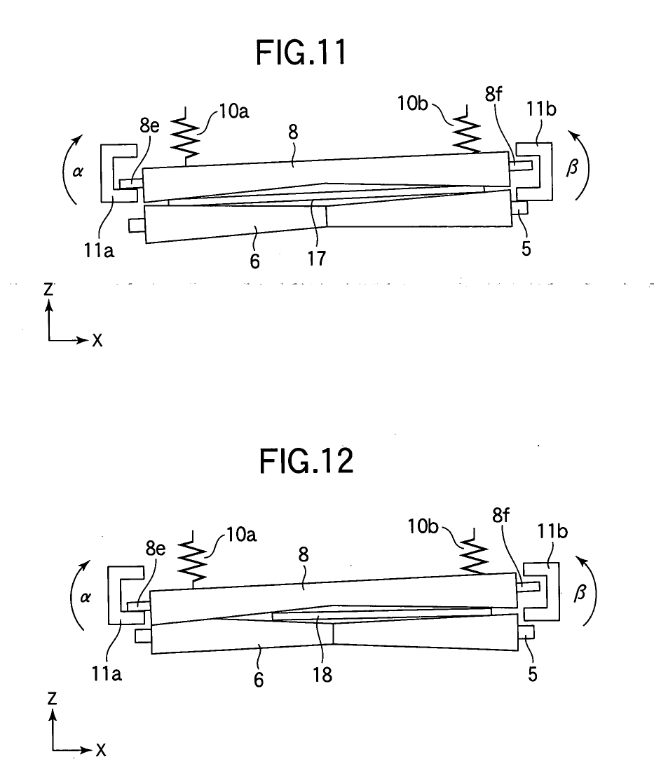

FIG. 11 is a view showing the disk loading device when the optical disk 17 of large diameter is inserted therein in a state where the driving roller 6 is obliquely mounted, as seen from the insertion openings 1a and 2a side (FIG. 1). As shown in FIG. 11, due to the engagement between the shaft receiving portions 11a and 11b of the cover chassis 2 and the swinging shafts 8e and 8f, the disk guide 8 is inclined in the direction β in the figure following the inclination of the driving roller 6. With this, both edges of the optical disk 17 in the X direction are held by the pressing portions 8a, 8b, 8c and 8d of the disk guide 8 and the driving roller 6 therebetween with even force. As a result, the difference in friction force applied to the optical disk 17 by the driving roller 6 becomes even at both edges of the optical disk 17 in the X direction, and therefore the optical disk 17 is correctly fed without shifting from a predetermine feeding path.

Similarly, even when the distortion or warping of the disk guide 8 occurs in the fabrication stage, or even when the distortion or warping of the roller supporting member 4 occurs, the disk guide 8 is inclined so that the force with which the disk guide 8 and the driving roller 6 hold both edges of the optical disk 3 in the X direction therebetween becomes even. As a result, the difference in friction force applied to the optical disk 17 by the driving roller 6 becomes even at both edges of the optical disk 17 in the X direction, and therefore the optical disk 17 is correctly fed along the predetermine feeding path.

FIG. 12 is a view showing the disk loading device when the optical disk 18 of small diameter (for example, 8 cm in diameter) is inserted to a position shifted from the center of the driving roller 6, as seen from the insertion openings 1a and 2a side (FIG. 1). As shown in FIG. 12, due to the engagement between the shaft receiving portions 11a and 11b of the cover chassis 2 and the swinging shafts 8e and 8f, the disk guide 8 is inclined in the direction β in the figure following the inclination of the driving roller 6, so that both edges of the optical disk 18 in the X direction are held by the pressing portions 8a, 8b, 8c and 8d of the disk guide 8 and the driving roller 6 therebetween with even force. As a result, the difference in friction force applied to the optical disk 18 by the driving roller 6 becomes even at both edges of the optical disk 18 in the X direction, and therefore the optical disk 18 is correctly fed along the predetermine feeding path.

As described above, according to this embodiment, the inclination of the disk guide 8 changes so that both edges of the optical disk 3 in the X direction are held with even force. Therefore, even if the driving roller 6 or the like is inclined due to an error in the fabrication stage or the like, or even if the optical disk 3 is inserted to a position shifted from the center, it is possible for the disk guide 8 and the driving roller 6 to hold both edges of the optical disk 3 in the X direction therebetween with even force. As a result, the optical disk 3 is correctly fed along the predetermined feeding path. In other words, it is possible to prevent the optical disk 3 from abutting against other components, and to prevent the stoppage of the feeding due to the increase of the feeding load of the driving roller 6.

Further, the dimensions of the respective grooves of the shaft receiving portions 11a and 11b (of the main chassis 2) in the Z direction are set longer than the outer diameters of the swinging shafts 8e and 8f of the disk guide 8, and therefore the inclination of the disk guide 8 becomes changeable with a simple structure.

Furthermore, the swinging shafts 8a and 8b are supported in the shaft receiving portions 11a and 11b using the screws 9a and 9b (and their washers) so that the swinging shafts 8a and 8b do not drop out thereof, and therefore the operation for mounting the swinging shafts 8e and 8f to the shaft receiving portions 11a and 11b becomes easy, so that the assembling of the disk device becomes easy.

Further, the driving roller 6 faces the groove portions 8n and 8p between the pressing portions 8a and 8b and the pressing portions 8c and 8d of the disk guide 8. Therefore, even when, for example, the optical disk 3 of small diameter is inserted to a position shifted from the center of the driving roller 6 in the X direction causing the inclination of the disk guide 8, an end of the driving roller 6 in the X direction can escape into the groove 8n (or groove 8p) of the disk guide 8, and therefore it is possible to prevent the disk guide 8 and the driving roller 6 from abutting against each other.

Furthermore, the pressing portions 8a through 8d of the disk guide 8 are so shaped that the pressing portions 8a through 8d protrude to the driving roller side 6 as approaching to both ends in the X direction, and therefore both edges of the optical disk in the X direction can be held by the disk guide 8 and the driving roller 6 therebetween.

### Embodiment 2

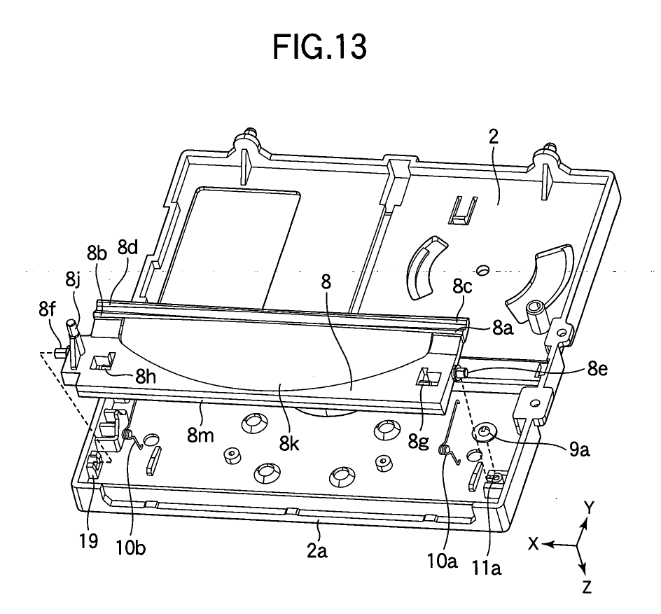

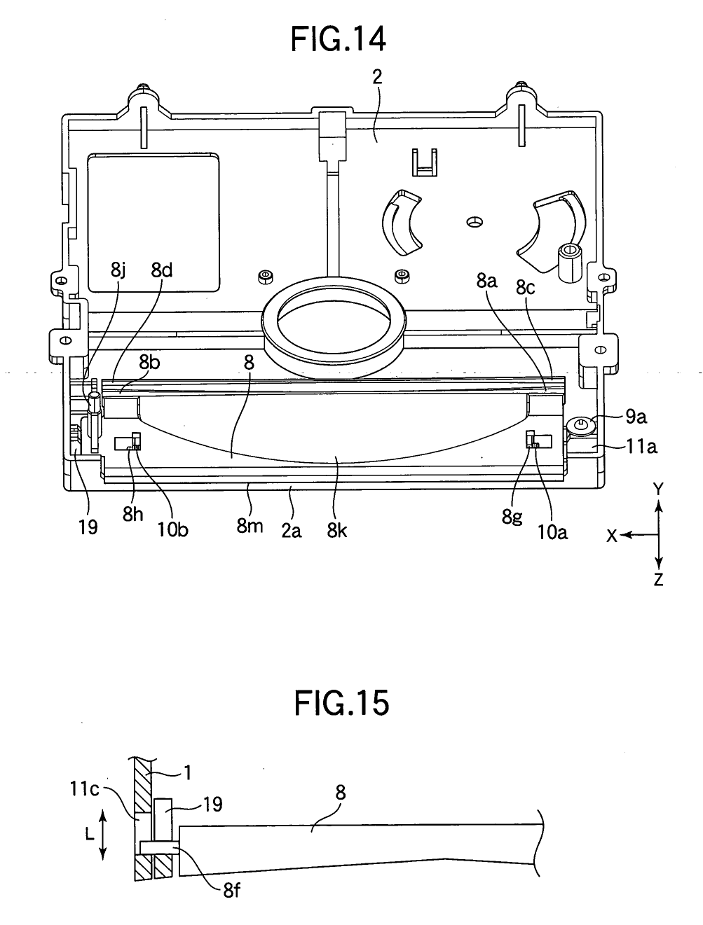

FIGS. 13 and 14 are an exploded perspective view and a perspective view showing a supporting structure of a disk guide 8 of a disk loading device according to Embodiment 2 of the present invention.

As shown in FIGS. 13 and 14, in this embodiment, one of the swinging shafts 8e and 8f (here, the swinging shaft 8f) of the disk guide 8 penetrates a shaft receiving portion 19 in the X direction, and is inserted into a hole portion 11c formed on the housing 1. FIG. 15 is a schematic view showing the hole portion 11c of the housing 1 in which the swinging shaft 8f is inserted. The tip of the swinging shaft 8f is inserted in the hole portion 11c of the housing 1, and the swinging shaft 8f is supported in the shaft receiving portion 19 so that the swinging shaft 8f dose not drop out thereof in the Z direction. As in Embodiment 1, the length L of the hole portion 11c in the Z direction is set longer than the outer diameter of the swinging shaft 8f so as to allow the inclination of the disk guide 8.

As shown in FIGS. 13 and 14, the other swinging shaft 8e of the disk guide 8 is inserted into the shaft receiving portion 11a, and is held by the screw 9a so that the swinging shaft 8e does not drop out thereof, as in Embodiment 1. The other configuration is the same as Embodiment 1.

With such a configuration, in this embodiment, in addition to the advantages having been described in Embodiment 1, it becomes unnecessary to provide one of screws 9a and 9b (here, the screw 9b), and therefore the number of components can be reduced and the manufacturing process can be simplified.

In the above described Embodiments 1 and 2, the disk device has been described as a home-use DVD player. However, the disk device is not limited to the DVD player, but can be a device that performs recording, reproducing or both of signals on the optical disk 3 as a recording medium.

Further, in the above described Embodiments 1 and 2, the mechanism for feeding the optical disk inserted through the insertion openings 1a and 2a has been described. However, the present invention is applicable to, for example, a device used in a disk changer for choosing an optical disk from an optical disk storing portion (which stores a plurality of optical disks) and feeding the optical disk to a disk device.

Further, in the above described Embodiments 1 and 2, the springs 10a and 10b are mounted to the disk guide 8, and the disk guide 8 and the driving roller 6 are kept parallel to each other by means of urging forces of the springs 10a and 10b. However, it is also possible to form the disk guide 8 using a resiliently deformable material, and to utilize a part of the disk guide 8 instead of the springs 10a and 10b.

1. A disk loading device comprising:
a driving roller that rotates to thereby feed a disk medium;
a disk guide including a pressing portion disposed in opposition to said driving roller and a swinging shaft for swinging said pressing portion toward and away from said driving roller;
a swinging supporting mechanism that supports said swinging shaft of said disk guide, and
an urging mechanism that urges said pressing portion of said disk guide so that said pressing portion is pressed against said driving roller,
wherein said swinging supporting mechanism supports said swinging shaft at both ends of said driving roller so that said swinging shaft is movable in a direction in which said pressing portion and said driving roller face each other, to thereby allow an inclination of said disk guide with respect to an axial direction of said driving roller to be changeable.

2. The disk loading device according to claim 1, wherein a pair of said swinging shafts are coaxially provided on said disk guide, and
wherein said swinging supporting mechanism includes a pair of shaft receiving portions respectively supporting said pair of said swinging shafts.

3. The disk loading device according to claim 2, wherein, in a direction in which said driving roller and said pressing portion face each other, a length of said shaft receiving portion is longer than an outer diameter of said swinging shaft so that said swinging shaft is movably supported in said shaft receiving portion.

4. The disk loading device according to claim 3, further comprising a screw for holding at least one of said swinging shafts so that said at least one of swinging shafts does not drop out of said shaft receiving portion.

5. The disk loading device according to claim 3, wherein at least one of said swinging shafts penetrates said shaft receiving portion in the axial direction.

6. The disk loading device according to claim 1, wherein said disk guide includes a plurality of pressing portions arranged in a direction of said feeding, and a groove is formed between said plurality of pressing portions, and
wherein said driving roller faces said groove of said disk guide.

7. The disk loading device according to claim 1, wherein said pressing portion has a shape such that said pressing portion protrudes to said driving roller side as approaching to both ends of said driving roller in the axial direction.

8. A disk device comprising:
a disk loading device according to claim 1;
a turntable that holds and rotates said disk medium loaded by said disk loading device, and
a head that performs a recording, reproducing or both of signals on said disk medium rotated by said turntable.
